(19) United States
(12) Patent Application Publication
(10) Pub. No.: US 2007/0241475 A1
(43) Pub. Date: Oct. 18, 2007

(54) Manufacturing process of high performance conductive polymer composite bipolar plate for fuel cell

(75) Inventors: Chen-Chi Martin Ma, Hsinchu (TW); Shu-Hang Liao, Hsinchu (TW); Chiaun-Iou Yen, Hsinchu (TW); Yu-Feng Lin, Hsinchu (TW); Chih-Hung Hung, Hsinchu (TW)

Correspondence Address: BACON & THOMAS, PLLC, 625 SLATERS LANE, FOURTH FLOOR, ALEXANDRIA, VA, 22314, US

(73) Assignee: National Tsing Hua University, Hsinchu (TW)

(21) Appl. No.: 11/438,333

(22) Filed: May 23, 2006

(30) Foreign Application Priority Data
Apr. 17, 2006 (TW) 95113694

(51) Int. Cl. B27N 3/00

(52) U.S. Cl. 264/105; 264/109

(57) ABSTRACT

A composite bipolar plate for a polymer electrolyte membrane fuel cell (PEMFC) is prepared as follows: a) compounding vinyl ester and graphite powder to form bulk molding compound (BMC) material, the graphite powder content ranging from 60 wt % to 95 wt % based on the total weight of the graphite powder and vinyl ester, wherein 0.5-10 wt % modified organo clay by intercalating with a polyether amine, based on the weight of the vinyl ester resin, is added during the compounding; b) molding the BMC material from step a) to form a bipolar plates having a desired shaped at 80-200° C. and 500-4000 psi.

### FIELD OF THE INVENTION

The present invention relates to a method for preparing a fuel cell composite bipolar plate, particularly a method for preparing a polymer/conductive carbon composite bipolar plate for a fuel cell by a bulk molding compound (BMC) process.

### BACKGROUND OF THE INVENTION

Taiwan Patent Publication No. 399348 discloses a method for preparing a bipolar plate, which comprises: mixing at least an electrically conductive material, at least a resin, and at least a hydrophilic agent suitable for a proton exchange membrane fuel cell, to form a substantially. homogeneous mixture wherein, based on the weight of said mixture, said at least an electrically conductive material is about 50% to about 9.5% and said at least a resin is about 5%; and molding said mixture to form a bipolar plate with a desired shape at a temperature of about 250° C. to about 500° C. and a pressure of about 500 psi to about 4000 psi, wherein said at least a resin is selected from the group consisting of thermosetting resins, thermoplastic resins, and a mixture thereof, and said at least an electrically conductive material is selected from the group consisting of graphite, carbon black, carbon fiber, and a mixture thereof.

U.S. Pat. No. 6,248,467 discloses a fuel cell composite bipolar plate, wherein the particle size of the graphite powder is mainly in the range of 80 mesh-325 mesh. This patent teaches that the mixing of the resin becomes inhomogeneous during processing when the particle size of the graphite powder is larger than 150 μm. In one of the examples in the specification disclosed in this patent the composite bipolar plate prepared from vinyl ester and graphite powder, the graphite powder content ranging from 60 wt % to 95 wt % based on the total weight of the graphite powder and vinyl ester, has a flexural strength of 28.2-40 MPa and a conductivity up to 85 S/cm.

WO 00/57506 discloses a highly conductive molding composition for molding a fuel cell bipolar plate, wherein the particle size of the graphite powder used is mainly in the range of 44 μm to 150 μm, wherein the amount of the graphite powder larger than 150 μm needs to be lower than 10%, and the amount of the graphite powder smaller than 44 μm also needs to be lower than 10%.

U.S. Pat. No. 4,301,222 discloses a thin electrochemical cell separator plate with greatly improved properties made by molding and then graphitizing a mixture of preferably 50 percent high purity graphite powder and 50 percent carbonizable thermosetting phenolic resin, the graphite molding powder particles having a specified preferred shape and a size distribution requiring 31 to 62 weight percent of the particles to be less than 45 microns in size.

U.S. Pat. No. 6,811,917 disclosed a conductive, moldable composite material for the manufacture of electrochemical cell components comprising a thermosetting resin system and conductive filler, wherein the thermosetting resin composition comprises: (1) a polybutadiene or polyisoprene resin; (2) an optional functionalized liquid polybutadiene or polyisoprene resin; (3) an optional butadiene- or isoprene-containing copolymer; and (4) an optional low molecular weight polymer. In a preferred embodiment, the conductive moldable composite material is used to form a bipolar plate, current collector or other electrochemical cell component. A composite bipolar plate made in this patent has a flexural strength of 26.3 MPa, a volume resistivity of 0.0253 ohm-cm (at 3.18 mm) and a linear shrinkage of 0.653%, which contains 28.04 wt % of liquid polybutadiene resin and 52.28 wt % of graphite powder having an average particle size of 25 μm.

US patent publication No. 2002-004156 discloses a separator for a fuel cell, which is manufactured by preparing a raw material powder, uniformly mixing the prepared raw material to be formed into a slurry, and charging the raw material powder derived from granulation into a metal mold for heat press forming. The raw material is obtained by adding to carbon powder a binder containing a mixture of phenolic resin and epoxy resin. Therefore the heat press forming step does not cause the binder to generate gas, thus allowing manufacturing of a separator exhibiting sufficient gas-impermeability

US patent publication No. 2005-089744 discloses a composite material for a bipolar plate of fuel cells, which is comprised of conductive carbon dispersed in polybenzoxazine matrix. This patent also provides a composite material for preparing a bipolar plate for fuel cells comprising a polybenzoxazine and conductive carbon in a ratio of 2:1, where a volume reduction percent of the composite material is less than 1%.

U.S. Pat. No. 4,214,969 discloses a bipolar current collector-separator for electrochemical cells, which consists of a molded aggregate of electro-conductive graphite and a thermoplastic fluoropolymer combined in a weight ratio of 2.5:1 to 16:1. A composite bipolar plate made in this patent has a flexural strength of 37.2 MPa, and a conductivity of 119 S/cm, which is prepared from PVDF (Kynar®) and 74 wt % of graphite powder.

US patent publication No. 2004191608 discloses a method of making a current collector plate for use in a proton exchange membrane fuel cell. The method includes the steps of: (a) molding the current collector plate by injection, compression or any other molding process from a resin/conductive filler composition; (b) measuring the current collector plate's average thickness; (c) measuring the current collector plate's through-plane resistivity; (d) removing a portion of the current collector plate's surface layer by abrasion; and (e) repeating steps (a) to (d) until a desired plate thickness is removed. The desired plate thickness removed is no more than about 10 micrometers, and preferably about 5 micrometers.

US patent publication No. 2005-0001352 A1 commonly assigned to the assignee of the present application discloses a composite bipolar plate of polymer electrolyte membrane fuel cells (PEMFC) prepared as follows: a) preparing a bulk molding compound (BMC) material containing a vinyl ester resin and a graphite powder, the graphite powder content of BMC material ranging from 60 wt % to 80 wt %, based on the compounded mixture; b) molding the BMC material from step a) to form a bipolar plate having a desired shape at 80-200° C. and 500-4000 psi, wherein the graphite powder is of 40 mesh-80 mesh. Details of the disclosure in US patent publication No. 2005-0001352 A1 are incorporated herein by reference.

Taiwan patent application No. 93141542 commonly assigned to the assignee of the present application discloses a polymer composite bipolar plate for a polymer electrolyte membrane fuel cell (PEMFC), which is prepared as follows: a) compounding phenolic resin and carbon fillers to form bulk molding compound (BMC) material, the BMC material containing 60 to 80 wt % graphite powder, 1 to 10 wt % carbon fiber; and one ore more conductive carbon fillers selected from: 5 to 30 wt % Ni-planted graphite powder, 2 to 8 wt % Ni-planted carbon fiber and 0.01 to 0.3 wt % carbon nanotubes, based on the weight of the phenolic resin, provided that the sum of the amounts of the carbon fiber and Ni-planted carbon fiber is not greater than 10 wt %; b ) molding the BMC material from step a) to form a bipolar plates having a desired shape at 80-200° C. and 500-4000 psi.

U.S. patent application Ser. No. 11/175141 commonly assigned to the assignee of the present application discloses a composite bipolar plate for a polymer electrolyte membrane fuel cell (PEMFC), which is prepared as follows: a) compounding vinyl ester and graphite powder to form bulk molding compound (BMC) material, the graphite powder content ranging from 60 wt % to 95 wt % based on the total weight of the graphite powder and vinyl ester, wherein carbon fiber 1-20 wt %, modified organo clay or noble metal plated modified organo clay 0.5-10 wt %, and one or more conductive fillers selected form: carbon nanotube (CNT) 0.1-5 wt %, nickel plated carbon fiber 0.5-10 wt %, nickel plated graphite 2.5-40 wt %, and carbon black 2-30 wt %, based on the weight of the vinyl ester resin, are added during the compounding; b) molding the BMC material from step a) to form a bipolar plate having a desired shaped at 80-200 ° C. and 500-4000 psi. Details of the disclosure in US patent publication No. 2005-0001352 A1 are incorporated herein by reference.

To this date, the industry is still continuously looking for a smaller fuel cell bipolar plate having a high electric conductivity, excellent mechanical properties, a high thermal stability and a high size stability.

### SUMMARY OF THE INVENTION

One primary objective of the present invention is to provide a small size fuel cell bipolar plate having a high electrical conductivity, excellent mechanical properties, a high thermal stability and a high size stability.

Another objective of the present invention is to provide a method for preparing a small size fuel cell bipolar plate having a high electrical conductivity, excellent mechanical properties, a high thermal stability and a high size stability.

The process for preparing a composite bipolar plate for a polymer electrolyte membrane fuel cell (PEMFC) according to the present invention uses a bulk molding compound (BMC) material containing comprising vinyl ester, a conductive carbon and a modified organo clay. The modified organo clay is prepared by intercalating with a polyether amine having a molecular weight greater than 200, preferably a polyether diamine having a weight-averaged molecular weight of 230-4000. The composite bipolar plate prepared according to the method of the present invention has an enhanced conductivity and mechanical properties, and meets the flame retardancy requirements.

In one of the preferred embodiments of the present invention, a high performance vinyl ester/graphite composite bipolar plate was prepared from a modified organo clay having a interlayer space of 54 Å by intercalating with poly(propylene glycol)-bis-(2-aminopropyl ether) having a weight-averaged molecular weight of 2000, which has a volume conductivity greater than 200 S/cm and a flexural strength as high as about 44 MPa. The volume conductivity greater than 200 S/cm is significantly higher than the technical criteria index of 100 S/cm of DOE of US.

In order to accomplished of the aforesaid objectives a process for preparing a composite bipolar plate for a polymer electrolyte membrane fuel cell (PEMFC) according to the present invention comprising:

a) compounding vinyl ester and graphite powder to form bulk molding compound (BMC) material, the graphite powder content ranging from 60 wt % to 95 wt % based on the total weight of the graphite powder and vinyl ester, wherein 0.5-10 wt % modified organo clay by intercalating with a polyether amine, based on the weight of the vinyl ester resin, is added during the compounding;

b) molding the BMC material from step a) to form a bipolar plate having a desired shaped at 80-200 ° C. and 500-4000 psi.

Preferably, said modified organo clay in step a) is prepared by conducting an cationic exchange between the polyether amine and a clay in an acidic solution, separating the resulting ion-exchanged clay from the acidic solution, and drying the ion-exchanged clay, wherein the polyether amine is used in a ratio of the polyether amine to the clay of 1-300% by weight. More preferably, the polyether amine is polyether diamine having two terminal amino groups, such as poly(propylene glycol)-bis-(2-aminopropyl ether) and poly(butylene glycol)-bis-(2-aminobutyl ether). Preferably, the polyether diamine has a weight-averaged molecular weight of 200-4000, and more preferably about 2000.

Preferably, the clay suitable for use in the preparation of the modified organo clay comprises an inorganic layer-type clay having a specific surface area of 500-1000 m²/g, preferably not less than 750 m²/g, and a cation exchange capacity (CEC) of 50-140 meq/100 g. More preferably, the clay has an interlayer space of 8-100 Å. More preferably, the clay has an aspect ratio of 100-1000.

Examples of the clay suitable for use in the preparation of the modified organo clay are Montmorillonite, Saponite, Hectorite, Attapulgite, zirconium phosphate, Illite, Mica, Kaolinite or Chlorite. Among them Montmorillonite is preferred.

Preferably, particles of said graphite powder have a size of 10-80 mesh. More preferably, less than 10 wt % of the particles of the graphite powder are larger than 40 mesh, and the remaining particles of the graphite powder have a size of 40-80 mesh.

Preferably, a free radical initiator in an amount of 1-10% based on the weight of said vinyl ester resin is added during said compounding in step a). More preferably, said free radical initiator is selected from the group consisting of peroxide, hydroperoxide, azonitrile, redox systems, persulfates, and perbenzoates. Most preferably, said free radical initiator is t-butyl peroxybenzoate.

Preferably, a mold releasing agent in an amount of 1-10%, based on the weight of said vinyl ester resin is added during said compounding in step a). More preferably, said mold releasing agent is wax or metal stearate. Most preferably, said mold releasing agent is metal stearate.

Preferably, a low shrinking agent in an amount of 5-20%, based on the weight of said vinyl ester resin is added during said compounding in step a). More preferably, said low shrinking agent is selected from the group consisting of styrene-monomer-diluted polystyrene resin, copolymer of styrene and acrylic acid, poly(vinyl acetate), copolymer of vinyl acetate and acrylic acid, copolymer of vinyl acetate and itaconic acid, and terpolymer of vinyl acetate, acrylic acid and itaconic acid. Most preferably, said low shrinking agent is styrene-monomer-diluted polystyrene resin.

Preferably, a tackifier in an amount of 1-10%, based on the weight of said vinyl ester resin is added during said compounding in step a). More preferably, said tackifier is selected from the group consisting of alkaline earth metal oxides, alkaline earth metal hydroxides, carbodiamides, aziridines, and polyisocyanates. Most preferably, said tackifier is calcium oxide or magnesium oxide.

Preferably, a solvent in an amount of 10-35%, based on the weight of said vinyl ester resin is added during said compounding in step a). More preferably, said solvent is selected from the group consisting of styrene monomer, alpha-methyl styrene monomer, chloro-styrene monomer, vinyl toluene monomer, divinyl toluene monomer, diallylphthalate monomer, and methyl methacrylate monomer. Most preferably, said solvent is styrene monomer.

The vinyl ester resins suitable for use in the present invention have been described in U.S. Pat. No. 6,248,467 which are (meth)acrylated epoxy polyesters, preferably having a glass transition temperature (Tg) of over 180° C. Suitable examples of said vinyl ester resins include, but not limited to, bisphenol-A epoxy-based methacrylate, bisphenol-A epoxy-based acrylate, tetrabromo bisphenol-A epoxy-based methacrylate, and phenol-novolac epoxy-based methacrylate, wherein phenol-novolac epoxy-based methacrylate is preferred. Said vinyl ester resins have a molecular weight of about 500˜10000, and an acid value of about 4 mg/1 hKOH-40 mg/1 hKOH.

The method for preparing a small size composite bipolar plate according to the present invention, which uses a modified organo clay intercalated with a polyether amine without using carbon fibers to reinforce the composite bipolar plate, can effectively enhance mechanical properties, thermal stability, size stability and flame retardancy, without substantially sacrificing its conductivity, which still meets the commercial requirement.

### DETAILED DESCRIPTION OF THE INVENTION

According to the present invention, a composite bipolar plate is produced by a bulk molding compound (BMC) process using a vinyl ester resin and a modified organo clay.

In the following examples, the modified organ Montmorillonite was prepared as follows:

0.036 mole of polyether diamine and 0.036 mole of concentrated HCl acid were mixed by stirring for 15 minutes to form a homogenous solution. 30 g of Montmorillonite and 3000 ml of deionized water were mixed at 80° C. by stirring for 4 hours. The resulting solution and clay mixture were combined and stirred for 24 hours, from which the clay was filtered out and washed with deionized water until no white precipitate of AgCl was formed when the spent water was titrated with an aqueous solution AgNO₃, followed by drying the washed clay in an oven at 100° C., and grounding and sieving the dried clay to obtain modified organ clay.

In the following examples and controls, the vinyl ester resins and initiators used are:

Vinyl ester resin: phenolic-novolac epoxy-based (methacrylate) resin having the following structure, which is available as code SW930-10 from SWANCOR IND. CO., LTD, No. 9, Industry South 6 Rd, Nan Kang Industrial Park, Nan-Tou City, Taiwan: 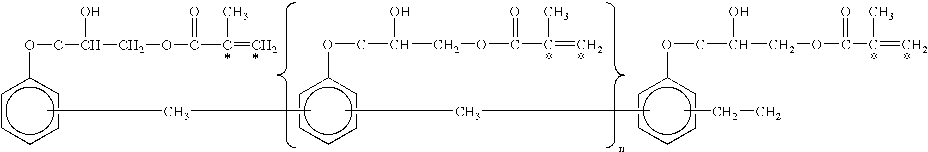
wherein n=1˜3.

Initiator: t-Butyl peroxybenzoate (TBPB) having the following structure, which is available as code TBPB-98 from Taiwan Chiang-Ya Co, Ltd., 4 of 8^{th} Fl, No.345, Chunghe Rd, Yuanhe City, Taipei Hsien:

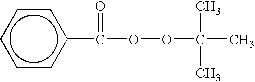

Polyether diamine: Jeffamine® D-series, available from Hunstsman Corp., Philadelphia, Pa., having the following structure: 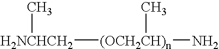
Jeffamine® D-230 (n=2˜3); Mw˜230
Jeffamine® D-400 (n=5˜6); Mw˜400
Jeffamine® D-2000 (n=33); Mw˜2000

### CONTROL EXAMPLE 1

The graphite powder used in Control Example 1 consisted of not more than 10% of particles larger than 40 mesh (420 μm in diameter), about 40% of particles between 40 mesh and 60 mesh (420-250 μm in diameter), and about 50% of particles between 60 mesh and 80 mesh (250-177 μm in diameter).

Preparation of BMC Material and Specimen

1. 192 g of a solution was prepared by dissolving 144 g of vinyl ester resin resin and 16 g of styrene-monomer-diluted polystyrene (as a low shrinking agent) in 32 g of styrene monomer as a solvent. 3.456 g of TBPB was added as an initiator, 3.456 g of MgO was added as a tackifier, and 6.72 g of zinc stearate was added as a mold releasing agent.
2. 3.84 g of Montmorillonite was added to the solution resulting from step 1, which was then agitated in a motorized mixer at room temperature for 15 minutes. The Montmorillonite has an aspect ratio of 100:1; a width of 100 nm; a specific surface area of 750 m²/g; a thickness of 1 nm; a cation exchange capacity (CEC) of 120 meq/100 g; and an interlayer space of 12.6 ÅA.
3. The mixture resulting from step 2, and 576 g of graphite powder were poured into a Bulk Molding Compound (BMC) kneader to be mixed homogeneously by forward-and-backward rotations for a kneading time of about 30 minutes. The kneading operation was stopped and the mixed material was removed from the mixer to be tackified at room temperature for 48 hours.
4. Prior to thermal compression of specimens, the material was divided into several lumps of molding material with each lump weighing 3 g.
5. A slab mold was fastened to the upper and lower platforms of a hot press. The pre-heating temperature of the molds were set to 140° C. After the temperature had reached the set point, the lump was disposed at the center of the molds and pressed with a pressure of 3000 psi to form a specimen. After 300 seconds, the mold was opened automatically, and the specimen was removed.

### EXAMPLES 1-3

The steps in Control Example 1 were repeated to prepare lumps of molding material and specimens, except that the Montmorillonite used in step 2 was replaced with modified organo Montmorillonite. The modified organo Montmorillonite and the amount thereof added are listed in Table 1.

TABLE 1

| Examples | Clays | Amount added, g (%)* |
|---|---|---|
| 1 | D230 modified Montmorillonite⁺ | 3.84 (0.5%) |
| | (D230/MMT) | |
| 2 | D400 modified Montmorillonite | 3.84 (0.5%) |
| | (D400/MMT) | |
| 3 | D2000 modified Montmorillonite | 3.84 (0.5%) |
| | (D2000/MMT) | |

*%, based on the sum of the weights of vinyl ester resin and graphite powder.
⁺Montmorillonite modified with Jeffamine ® D-series polyether diamines: the interlayer space of D230/Montmorillonite, D400/Montmorillonite and D2000/Montmorillonite are 13.9 Å, 17.7 Å and 54 Å, respectively.

Electrical Properties:
Test Method:

A four-point probe resistivity meter was used by applying a voltage and an electric current on the surface of a specimen at one end, measuring at the other end the voltage and the electric current passed through the specimen, and using the Ohm's law to obtain the volume resistivity (p) of the specimen according to the formula,

$$ρ = \frac{V}{I} * W * CF , \qquad ( formula 1 )$$

wherein V is the voltage passed through the specimen, I is the electric current passed through the specimen, a ratio thereof is the surface resistivity, W is the thickness of the specimen, and CF is the correction factor. The thermally compressed specimens from the example and the controls were about 100 mm×100 mm with a thickness of 1.5 mm. The correction factor (CF) for the specimens was 4.5. Formula 1 was used to obtain the volume resistivity (ρ) and an inversion of the volume resistivity is the electric conductivity of a specimen.
Results:

Table 2 shows the resistivity measured for the polymer composite bipolar plates prepared above and the interlayer space of the clays used in the preparation of the bipolar plates. The measured resistivities for the polymer composite bipolar plates prepared in Control Example 1 and Examples 1-3 respectively are 3.40 mΩ, 3.45 mΩ, 3.51 mΩ, and 3.60 mΩ. Table 3 shows the electric conductivity measured for the polymer composite bipolar plates prepared above and the interlayer space of the clays used in the preparation of the bipolar plates. The measured conductivities for the polymer composite bipolar plates prepared in Control Example 1 and Examples 1-3 respectively are 294 S/cm, 290 S/cm, 285 S/cm and 278 S/cm. The results indicate that the change from the inorganic clay to the modified organo clay will not substantially affect the resistivity and conductivity of the bipolar plate.

TABLE 2

| | Interlayer space (Å) | Resistivity (mΩ) |
|---|---|---|
| Control Ex. 1 | 12.6 | 3.40 |
| Example 1 | 13.9 | 3.45 |
| Example 2 | 17.7 | 3.51 |
| Example 3 | 54.0 | 3.60 |

TABLE 3

| | Interlayer space (Å) | Conductivity (S/cm) |
|---|---|---|
| Control Ex. 1 | 12.6 | 294 |
| Example 1 | 13.9 | 290 |
| Example 2 | 17.7 | 285 |
| Example 3 | 54.0 | 278 |

Mechanical Property: Test for Flexural Strength
Method of Test: ASTM D790
Results:

Table 4 shows the test results of flexural strength for polymer composite bipolar plates prepared above and the interlayer space of the clays used in the preparation of the bipolar plates. The measured flexural strength for the polymer composite bipolar plates prepared in Control Example land Examples 1-3 respectively are 34.07±1.73 MPa, 36.15±1.29 MPa, 39.11±1.23 MPa and 44.39±1.27; and the measured flexural modulus for the polymer composite bipolar plates prepared in Control Example 1 and Examples 1-3 respectively are 8771, 14590, 16083 and 18106. The results indicate that addition of the modified organo clay will better enhance the flexural strength and modulus than the addition of inorganic clay, and the greater the interlayer space of the clay the greater of the flexural strength. In comparison with the results of Control Example 1 (interlayer space 12.60 Å) and Example 3 (interlayer space 54.0 Å), the flexural strength of the latter is 30% greater than that of the former, and the flexural modulus of the latter is 106% greater than that of the former.

TABLE 4

| | Interlayer space | Flexural strength | Flexural |
|---|---|---|---|
| | (Å) | (MPa) | modulus |
| Control Ex. 1 | 12.6 | 34.07 ± 1.73 | 8,771 |
| Example 1 | 13.9 | 36.15 ± 1.29 | 14,590 |
| Example 2 | 17.7 | 39.11 ± 1.23 | 16,083 |
| Example 3 | 54.0 | 44.39 ± 1.27 | 18,106 |

Mechanical Property: Test for Impact Strength
Method of Test: ASTM D256
Results:

Table 5 shows the test results of notched Izod impact strength for polymer composite bipolar plates prepared above and the interlayer space of the clays used in the preparation of the bipolar plates. The measured notched Izod impact strength for the polymer composite bipolar plates prepared in Control Example 1 and Examples 1-3 respectively are 62.48 J/m, 64.61 J/m, 68.72 J/m and 78.98 J/m. The results indicate that addition of the modified organo clay will better enhance the notched Izod impact strength than the addition of inorganic clay, and the greater the interlayer space of the clay the greater of the impact strength. In comparison with the results of Control Example 1 (interlayer space 12.60 Å) and Example 3 (interlayer space 54.0 Å), the impact strength of the latter is 26% greater than that of the former.

TABLE 5

| | Interlayer space (Å) | Impact strength (J/m) |
|---|---|---|
| Control Ex. 1 | 12.6 | 62.48 |
| Example 1 | 13.9 | 64.61 |
| Example 2 | 17.7 | 68.72 |
| Example 3 | 54.0 | 78.98 |

Size Stability Property: Test for Shrinkage
Method of Test: ASTM D955
Results:

Table 6 shows the test results of shrinkage for polymer composite bipolar plates prepared above and the interlayer space of the clays used in the preparation of the bipolar plates. The measured shrinkage for the polymer composite bipolar plates prepared in Control Example 1 and Examples 1-3 respectively are 0.14%, 0.145%, 0.16% and 0.18%, which are less than 1.0% disclosed in the above-mentioned US2005-089744 and 0.653% disclosed in the above-mentioned U.S. Pat. No. 6,811,917. The results indicate that the bipolar plates of the present invention have significantly lower shrinkage in comparison with US2005-089744 and U.S. Pat. No. 6,811,917, and an excellent size stability.

TABLE 6

| | Interlayer space (Å) | Shrinkage (%) |
|---|---|---|
| Control Ex. 1 | 12.6 | 0.14 |
| Example 1 | 13.9 | 0.145 |
| Example 2 | 17.7 | 0.16 |
| Example 3 | 54.0 | 0.18 |

Corrosion Property Test:
Method of Test: ASTM G5-94
Results:

Table 7 shows the test results of corrosion electric current test for polymer composite bipolar plates prepared above and the interlayer space of the clays used in the preparation of the bipolar plates. The measured corrosion electric current for the polymer composite bipolar plates prepared in Control Example 1 and Examples 1-3 respectively are 7.9×10⁻⁷, 6.0×10⁻⁷, 3.5×10⁻⁷ and 5.4×10⁻⁸Amps/cm². The results indicate that addition of clay will lower the corrosion electric current, and the larger the interlayer space of the clay is the smaller the corrosion electric current is. The corrosion electric current of a level of 10⁻⁷ and 10⁻⁸ Amps/cm² as shown in Table 8 indicate the bipolar plates have an excellent anti-corrosion property.

TABLE 7

| | | Corrosion electric |
|---|---|---|
| | Interlayer space (Å) | current (Amps/cm²) |
| Control Ex. 1 | 12.6 | 7.9 × 10⁻⁷ |
| Example 1 | 13.9 | 6.0 × 10⁻⁷ |
| Example 2 | 17.7 | 3.5 × 10⁻⁷ |
| Example 3 | 54.0 | 5.4 × 10⁻⁸ |

Flame Retardancy Property: UL-94 Test
Method of Test: ASTM D-3801
Results:

A vertical combustion method specified in the flame retardancy standard was used, wherein the flame retardancy is classified into 94V-0, 94V-1 or 94V-2. During the testing, all specimens prepared in Examples 1-3 and Control Example 1 did not drip and, therefore, did not cause a cotton ball to burn.

Table 8 shows the test results of flame retardancy for polymer composite bipolar plates prepared above and the interlayer space of the clays used in the preparation of the bipolar plates. The measured flame retardancy for all composite bipolar plates all meet 94V-0 in the UL-94 test.

TABLE 8

| | Interlayer | Dripping of | | |
|---|---|---|---|---|
| | space | molten | Combustion | |
| | (Å) | material | of cotton | UL-94 |
| Control Ex. 1 | 12.6 | N/A^{a)} | N/A | 94V-0 |
| Example 1 | 13.9 | N/A | N/A | 94V-0 |
| Example 2 | 17.7 | N/A | N/A | 94V-0 |
| Example 3 | 54.0 | N/A | N/A | 94V-0 |

^{a)}not found

Property of Flame Retardancy: Test of Limit Oxygen Index, (LOI)
Method of Test: ASTM D-2863
Results:

The Limit Oxygen Index (LOI) test is the most commonly used method for testing the flame retardancy property of a polymer substrate. Usually, the LOI is defined by the following formula:

$$LOI = \frac{[ {O}_{2} ]}{[ {O}_{2} ] + [ {N}_{2} ]} \times 100$$

wherein [O2] and [N2] separately are the volumetric flowrate (ml/sec) of oxygen and nitrogen. Usually, the relationship between the oxygen index and the combustion property is classified into the following three grades:

LOI≦21→combustible

LOI=22˜25→self-extinguishing (not easy to burn)

LOI≧26→difficult to burn

The LOI is used to determine the minimum oxygen concentration required for sustaining a flame in a mixture system of flowing oxygen and nitrogen in room temperature.

A vinyl ester resin with a high Tg value used in the example and controls had an LOI<21. Table 9 shows the test results of flame retardancy for the polymer composite bipolar plates prepared above by using 75 wt % of graphite powder with 0.5 wt % of inorganic clay and modified organo clays, wherein the interlayer space of the clays respectively are 12.6 Å, 13.9 Å, 17.7 Å and 54.0 Å. The measured LOI for all composite bipolar plates with a graphite powder content of 75 wt % and with 0.5 wt % of inorganic clay and modified organo clays having a different interlayer space are all larger than 50.

TABLE 9

| | Interlayer | Dripping of | Combustion of | |
|---|---|---|---|---|
| | space | molten | absorbent | |
| | (Å) | material | cotton | LOI |
| Control Ex. 1 | 12.6 | N/A^{a)} | N/A | >50 |
| Example 1 | 13.9 | N/A | N/A | >50 |
| Example 2 | 17.7 | N/A | N/A | >50 |
| Example 3 | 54.0 | N/A | N/A | >50 |

^{a)}not found

The compositions for the BMC process in Control Example 1 and Examples 1-3 are all the same except that the clays added are different. The graphite powder of Control Example 1 and Examples 1-3 consists of not more than 10% of particles larger than 420 μm in diameter (<40 mesh), about 40% of particles between 40 mesh and 60 mesh (420 μm˜250 μm in diameter), and about 50% of particles between 60 mesh and 80 mesh (250 μm˜177 μm in diameter). The interlayer space (d-space) of the clays increases from Control Example 1 to Example 3, and thus the chance for molecules entering the interlayer galleries of the clay also increases. That means the contact area between the molecules and the clay will significantly increases, and the interacting force at the contact interface thereof also increase. Consequently, a polymer formed by undergoing a crosslinking reaction in a resin/clay matrix will relatively easier intercalate the space between the layers of the clay having a larger interlayer space, so that a nano-composite having enhanced mechanical properties is formed.

In view of the above test results, the addition of a small amount of a modified organo clay can improve the mechanical properties including a low shrinkage characteristic without substantially affecting the conductivity of a polymer composite bipolar plate. The small size polymer composite bipolar plate prepared in accordance with the method of the present invention is therefore readily to be applied commercially in view of its comprehensive performance. In the following Table 10, the conductivity and flexural strength of the polymer composite bipolar plates prepared in the prior art and Example 3 of the present invention are listed. It can be seen from Table 10 that the polymer composite bipolar plate prepared in Example 3 of the present invention has the best performance in conductivity and flexural strength. Moreover, the polymer composite bipolar plate prepared in the present invention is reinforced with organo clay, which is much cheaper than carbon fiber, and thus has an edge in raw material cost.

TABLE 10

| | | | Flexural | |
|---|---|---|---|---|
| | Filler, | Conductivity | strength | |
| Resin | wt % | (S/cm) | (MPa) | Source |
| PVDF | Graphite | 119 | 37.2 | U.S. Pat. No. |
| | 74% | | | 4,214,969 |
| PVDF | Graphite, | 109 | 42.7 | U.S. Pat. No. |
| | 74% and | | | 4,339,332 |
| | carbon | | | |
| | fibers | | | |
| Vinyl | Graphite, | 85 | 40 | U.S. Pat. No. |
| ester | 68% | | | 6,248,467 |
| Vinyl | Graphite, | 114 | 31.25 | U.S. Pub. No. |
| ester | 75% | | | 2005/0001352 |
| Poly- | Graphite, | 40 | 27.33 | U.S. Pat. No. |
| butadiene | 52.28% | | | 6,811,917 |
| | and carbon | | | |
| | fibers | | | |
| Vinyl | Graphite, | 275 | 44.39 | Example 3 of |
| ester | 75% and | | | this invention |
| | organo clay | | | |

1. A method for preparing a fuel cell composite bipolar plate, which comprises:
a) compounding vinyl ester and graphite powder to form bulk molding compound (BMC) material, the graphite powder content ranging from 60 wt % to 95 wt % based on the total weight of the graphite powder and vinyl ester, wherein 0.5-10 wt % modified organo clay by intercalating with a polyether amine, based on the weight of the vinyl ester resin, is added during the compounding;
b) molding the BMC material from step a) to form a bipolar plate having a desired shaped at 80-200 ° C. and 500-4000 psi.

2. The method as claimed in claim 1, wherein said modified organo clay in step a) is prepared by conducting an cationic exchange between the polyether amine and a clay in an acidic solution, separating the resulting ion-exchanged clay from the acidic solution, and drying the ion-exchanged clay, wherein the polyether amine is used in a ratio of the polyether amine to the clay of 1-300% by weight.

3. The method as claimed in claim 2, wherein the polyether amine is polyether diamine having two terminal amino groups.

4. The method as claimed in claim 3, wherein the polyether diamine is poly(propylene glycol)-bis-(2-aminopropyl ether) or poly(butylene glycol)-bis-(2-aminobutyl ether).

5. The method as claimed in claim 4, wherein the polyether diamine has a weight-averaged molecular weight of 200-4000.

6. The method as claimed in claim 5, wherein the polyether diamine has a weight-averaged molecular weight of about 2000.

7. The method as claimed in claim 2, wherein the clay comprises an inorganic layer-type clay having a specific surface area of 500-1000 m²/g. and a cation exchange capacity (CEC) of 50-140 meq/100 g.

8. The method as claimed in claim 7, wherein the clay has an interlayer space of 8-100 Å.

9. The method as claimed in claim 7, wherein the clay has an aspect ratio of 100-1000.

10. The method as claimed in claim 7, wherein the clay has a specific surface area not less than 750 m²/g.

11. The method as claimed in claim 7, wherein the clay is Montmorillonite, Saponite, Hectorite, Attapulgite, zirconium phosphate, Illite, Mica, Kaolinite or Chlorite.

12. The method as claimed in claim 11, wherein the clay is Montmorillonite.

13. The method as claimed in claim 3, wherein particles of said graphite powder have a size of 10-80 mesh.

14. The method as claimed in claim 13, wherein less than 10 wt % of the particles of the graphite powder are larger than 40 mesh, and the remaining particles of the graphite powder have a size of 40-80 mesh.

15. The method as claimed in claim 5, wherein particles of said graphite powder have a size of 10-80 mesh.

16. The method as claimed in claim 15, wherein less than 10 wt % of the particles of the graphite powder are larger than 40 mesh, and the remaining particles of the graphite powder have a size of 40-80 mesh.

17. The method as claimed in claim 6, wherein particles of said graphite powder have a size of 10-80 mesh.

18. The method as claimed in claim 17, wherein less than 10 wt % of the particles of the graphite powder are larger than 40 mesh, and the remaining particles of the graphite powder have a size of 40-80 mesh.

19. The method as claimed in claim 7, wherein particles of said graphite powder have a size of 10-80 mesh.

20. The method as claimed in claim 19, wherein less than 10 wt % of the particles of the graphite powder are larger than 40 mesh, and the remaining particles of the graphite powder have a size of 40-80 mesh.
